(19) United States
(12) Patent Application Publication
(10) Pub. No.: US 2026/0302966 A1
(43) Pub. Date: Oct. 1, 2026

(54) SINGLE STAGE ISOLATED AC/DC POWER SUPPLY WITH INPUT SERIES OUTPUT PARALLEL (ISOP) STRUCTURE

(71) Applicant: Apple Inc., Cupertino, CA (US)

(72) Inventor: Noureldeen M. Elsayad, San Jose, CA (US)

(21) Appl. No.: 19/095,945

(22) Filed: Mar. 31, 2025

(51) Int. Cl. H02M 7/217

(52) U.S. Cl. CPC H02M 7/217

(57) ABSTRACT

An AC/DC power supply can include a full wave rectifier that receives an AC input voltage and produces a rectified AC voltage; a plurality of single stage AC/DC converter modules; and an inductor that couples the rectified AC voltage to a first converter module of the plurality of single stage AC/DC converter modules; wherein the plurality of single stage AC/DC converter modules have their inputs connected in series and their outputs connected in parallel. The plurality of single stage AC/DC converter modules can be two single stage AC/DC converter modules. The two single stage AC/DC converter modules can be driven 180 degrees out of phase with respect to each other. The plurality of single stage AC/DC converter modules can be driven 360/n degrees out of phase with respect to each other, where n is a number of single stage AC/DC converter modules in the plurality.

### BACKGROUND

Isolated AC/DC Power Supply Units (PSUs) (also called power supplies) are a component in many systems like consumer electronics, renewable energy systems, data centers, and electric vehicles. Such a power supply can perform functions such as: (1) converting an AC input voltage (e.g., from an electric plug or wall socket) to a DC voltage at a level required by a load (e.g. 5V, 12V, 48V, 400V, etc.); (2) ensuring that the input AC voltage from the grid is sinusoidal and in-phase with the AC input voltage; and (3) providing galvanic isolation between the AC grid and the load.

### SUMMARY

Improvements to these and other functions of such power supplies may be desirable. Disclosed herein is a single-stage (i.e., directly converts the AC input voltage to the desired DC voltage level of the load) power supply that has an Input-Series-Output-Parallel (ISOP) structure, as described in greater detail below. Such a topology can reduce the size of input and output filter components and/or improve thermal performance. As a result, such topologies can be good candidates for applications where the size and height of the PSU are important design aspects, although they may also be used in other applications.

An AC/DC power supply can include a full wave rectifier that receives an AC input voltage and produces a rectified AC voltage; a plurality of single stage AC/DC converter modules; and an inductor that couples the rectified AC voltage to a first converter module of the plurality of single stage AC/DC converter modules; wherein the plurality of single stage AC/DC converter modules have their inputs connected in series and their outputs connected in parallel. The plurality of single stage AC/DC converter modules can be two single stage AC/DC converter modules. The two single stage AC/DC converter modules can be driven 180 degrees out of phase with respect to each other. The plurality of single stage AC/DC converter modules can be driven 360/n degrees out of phase with respect to each other, where n is a number of single stage AC/DC converter modules in the plurality.

Each of the plurality of single stage AC/DC converter modules can include a switching half bridge including a high side switch and a low side switch, wherein a switch node of the switching half bridge is an input of the single stage AC/DC converter module; a transformer having a primary winding with a first terminal connected to a switch node of the switching half bridge; stacked switching capacitors respectively coupled between the switching half bridge and a second terminal of the primary winding of the transformer; a rectifier half bridge coupled to a first terminal of a secondary winding of the transformer and an output of the single stage AC/DC converter module; and stacked capacitors respectively coupled to the output of the single stage AC/DC converter module and between the rectifier half bridge and a second terminal of the secondary winding of the transformer. The rectifier half bridge can include synchronous rectifier switches. Respective high side and low side synchronous rectifier switches are driven by signals corresponding to corresponding high side and low side switches of the switching half bridge.

The AC/DC power supply can further include control circuitry including a voltage controller that compares a difference between an output voltage of the power supply to a reference voltage to generate an error signal provided to a controller that generates a current command signal for a current controller; and pulse width modulation circuitry that receives a modulation signal derived from the current command signal by the current controller and produces drive signals for switching devices of the plurality of single stage AC/DC converter modules by comparing the modulation signal to a plurality of phase shifted carriers, wherein the plurality of phase shifted carriers are shifted with respect to each other by 360/n degrees, where n is a number of single stage AC/DC converter modules in the plurality. The pulse width modulation circuitry produces complementary drive signals for respective high side and low side switches of each single stage AC/DC converter module.

An AC/DC power supply can include a full wave rectifier that receives an AC input voltage and produces a rectified AC voltage; a plurality of single stage AC/DC converter modules; and an inductor that couples the rectified AC voltage to a first converter module of the plurality of single stage AC/DC converter module. Each of the plurality of single stage AC/DC converter modules can include a switching half bridge including a high side switch and a low side switch, wherein a switch node of the switching half bridge is an input of the single stage AC/DC converter module; a transformer having a primary winding with a first terminal connected to a switch node of the switching half bridge; stacked switching capacitors respectively coupled between the switching half bridge and a second terminal of the primary winding of the transformer; a rectifier half bridge coupled to a first terminal of a secondary winding of the transformer and an output of the single stage AC/DC converter module; and stacked capacitors respectively coupled to the output of the single stage AC/DC converter module and between the rectifier half bridge and a second terminal of the secondary winding of the transformer. The plurality of single stage AC/DC converter modules have their inputs connected in series and their outputs connected in parallel.

The rectifier half bridge comprises synchronous rectifier switches. Respective high side and low side synchronous rectifier switches can be driven by signals corresponding to corresponding high side and low side switches of the switching half bridge. The plurality of single stage AC/DC converter modules can be two single stage AC/DC converter modules. The two single stage AC/DC converter modules are driven 180 degrees out of phase with respect to each other. The plurality of single stage AC/DC converter modules can be driven 360/n degrees out of phase with respect to each other, where n is a number of single stage AC/DC converter modules in the plurality.

The AC/DC power supply can further include control circuitry including a voltage controller that compares a difference between an output voltage of the power supply to a reference voltage to generate an error signal provided to a controller that generates a current command signal for a current controller; and pulse width modulation circuitry that receives a modulation signal derived from the current command signal by the current controller and produces drive signals for switching devices of the plurality of single stage AC/DC converter modules by comparing the modulation signal to a plurality of phase shifted carriers, wherein the plurality of phase shifted carriers are shifted with respect to each other by 360/n degrees, where n is a number of single stage AC/DC converter modules in the plurality. The pulse width modulation circuitry can produce complementary drive signals for respective high side and low side switches of each single stage AC/DC converter module.

A single stage AC/DC converter module can include a switching half bridge including a high side switch and a low side switch, wherein a switch node of the switching half bridge is an input of the single stage AC/DC converter module; a transformer having a primary winding with a first terminal connected to a switch node of the switching half bridge; stacked switching capacitors respectively coupled between the switching half bridge and a second terminal of the primary winding of the transformer; a rectifier half bridge coupled to a first terminal of a secondary winding of the transformer and an output of the single stage AC/DC converter module; and stacked capacitors respectively coupled to the output of the single stage AC/DC converter module and between the rectifier half bridge and a second terminal of the secondary winding of the transformer.

The rectifier half bridge can include synchronous rectifier switches. Respective high side and low side synchronous rectifier switches can be driven by signals corresponding to corresponding high side and low side switches of the switching half bridge.

### BRIEF DESCRIPTION OF THE DRAWINGS

FIG. 1 illustrates an isolated PSU with an ISOP converter in a two-stage configuration.

FIG. 2 illustrates a single-stage isolated AC-DC power supply with input-series-output-parallel (ISOP) converter modules.

FIG. 3 illustrates a single-stage isolated AC-DC power supply with ISOP converter modules and synchronous rectification.

FIG. 4 illustrates a voltage control loop of a single-stage isolated AC-DC power supply with ISOP converter modules.

FIG. 5 illustrates pulse width modulation (PWM) control signal generation for a single-stage isolated AC-DC power supply with ISOP converter modules.

FIG. 6 illustrates a switching sequence of a single-stage isolated AC-DC power supply with ISOP converter modules when a PWM duty cycle is >50%.

FIG. 7 illustrates a switching sequence of a single-stage isolated AC-DC power supply with ISOP converter modules when a PWM duty cycle is <50%.

FIG. 8 illustrates power flow of a single-stage isolated AC-DC power supply with ISOP converter modules when switches Q₁₂ and Q₂₂ are turned on.

FIG. 9 illustrates power flow of a single-stage isolated AC-DC power supply with ISOP converter modules when switches Q₁₂ and Q₂₂ are turned off.

FIG. 10 illustrates power flow of a single-stage isolated AC-DC power supply with ISOP converter modules when switches Q₁₂ is turned off and Q₂₂ is turned on.

FIG. 11 illustrates power flow of a single-stage isolated AC-DC power supply with ISOP converter modules when switches Q₁₂ is turned on and Q₂₂ is turned off.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

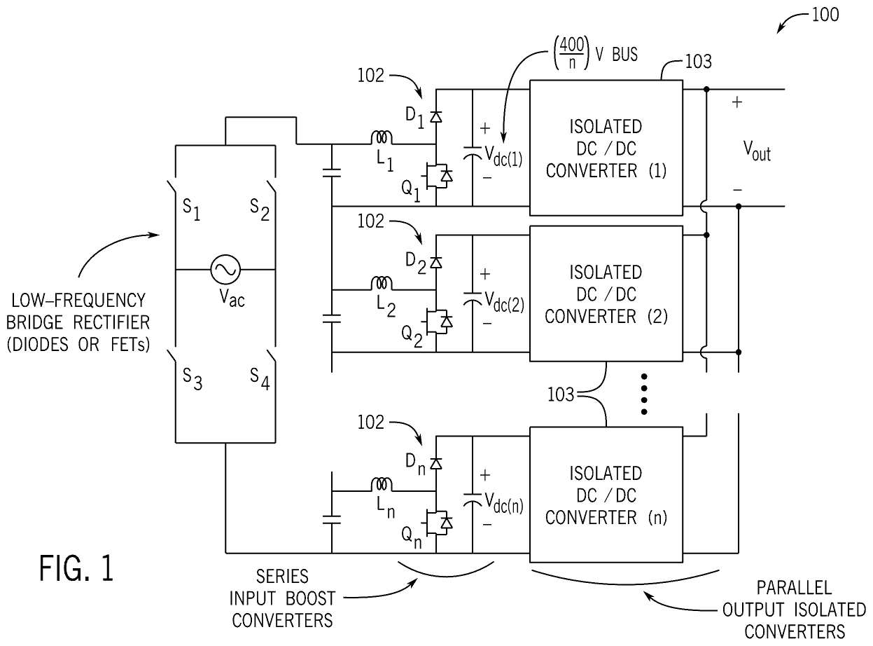

FIG. 1 illustrates an isolated power supply using an input-series-output-parallel converter as was described in Applicant's co-pending U.S. patent application Ser. No. 18/624,695, entitled, “Front-End Active Rectifier Using Single Inductor and Series Stacked Half Bridges For Isolated Power Supplies,” filed Apr. 2, 2024, which is hereby incorporated by reference in its entirety. By way of brief summary and context for the present disclosure, FIG. 1 illustrates such a topology. This power supply 100 can include multiple boost converters 102 having their inputs connected in series. Each boost converter can be connected to an isolated dc/dc converter 103, and the outputs of these isolated DC/DC converters can be connected in parallel, as depicted in FIG. 1.

Instead of having one high voltage bus (e.g., 400V), multiple boost converters 102 connected in-series can create multiple floating dc buses (e.g.,

$$( \frac{400}{n} ) V ,$$

where n is number of stages of the ISOP converter). The PWM signals of these boost converters can be phase-shifted, which can reduce the ripple current flowing through the EMI filter. This can reduce the size of the EMI filter. Both the boost converters 102 and the isolated dc/dc converters 103 can use MOSFETs and capacitors with lower voltage ratings because they only need to tolerate the

$$( \frac{400}{n} ) V$$

stress, rather than the full 400V (or other operating voltage). Both the thermal system size and the output capacitor of the ISOP converter can thus be reduced over other prior art designs. One potential drawback in some applications might be the utilization of multiple inductors, each having a current sensing circuit, which can complicate the system and increases its cost. Additionally, each inductor may have its own current control loop, which can further complicate the controller design.

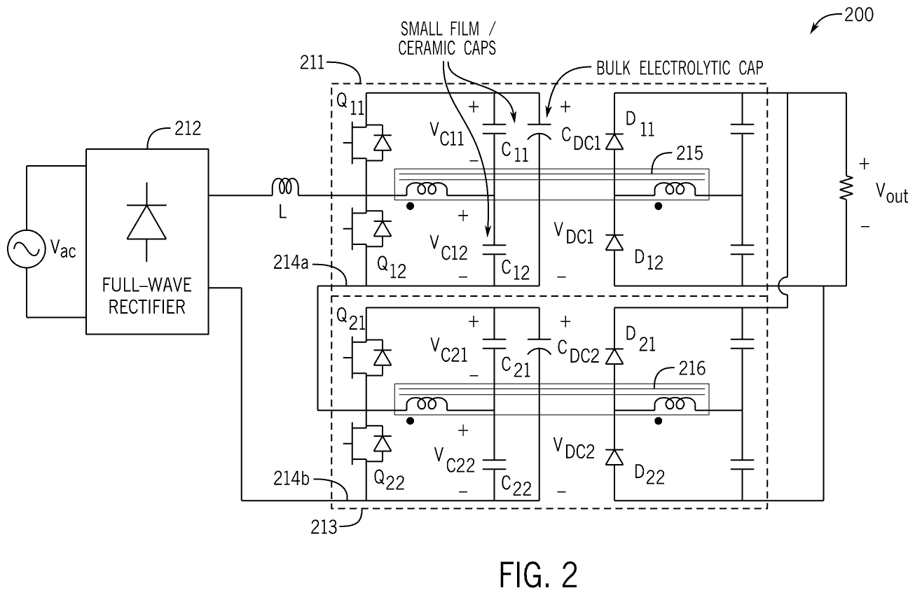

FIG. 2 illustrates an embodiment of a proposed isolated power supply 200 that is a single-stage isolated AC-DC power supply with ISOP converter modules. Power supply 200 includes a single power factor correction choke/inductor L connected to the switching node of a first half-bridge of a first converter module 211. The input side of inductor L is connected to the output of a full wave rectifier 212, which can rectify an input AC voltage AC. First converter module 211 can be connected in series to additional converter modules, e.g., second converter module 213. In the illustrated embodiment, two converter modules, each with respective input half bridges are illustrated, although additional converter modules could be provided, so as to provide a converter with 3, 4, . . . , or n converter modules having their inputs connected in series. The points of connection can be the switching node and the “ground” or low side rail of each input half-bridge of the respective converter modules. The switching node is the connection point of the high side switch Q11, Q21, etc. and the low side switch Q12, Q22, etc. of the respective half bridges. The ground or low side rail of each half bridge is the lower rail 214a, 214b, etc.

Transformers 215, 216 can have their primary windings connected between the switch node of each half bridge 211, 212 and a capacitor bridge midpoint, i.e., the junction point of primary side switching capacitors C₁₁/C₁₂ or C₂₁/C₂₂. Secondary windings of the transformers can be connected as described in greater detail below. Each input half bridge of the respective converter modules can further include separate bulk capacitors (V_{DC1}/V_{DC2}) that can be used to provide a required hold-up time. In some embodiments, the stacked capacitors C₁₁/C₁₂ and C₂₁/C₂₂ (i.e., the primary side switching capacitors) can be relatively smaller capacitance film or ceramic type capacitors, while the bulk capacitors can be relatively larger capacitance electrolytic capacitors. In any case, the DC bulk voltage can be split equally across the series connected inputs of the converter modules

$${V}_{DC 1} = {V}_{DC 2} = … = {V}_{Dcn} = ( \frac{400}{n} ) V ,$$

where n is number of converter modules). This assumes an example aggregate bulk voltage of 400V, although other aggregate bulk voltage could be used with the aggregate bulk voltage being divided evenly across the series-connected inputs of the converter modules

The secondary winding of each transformer can be connected to a half bridge rectifier made up of upper diodes D₁₁/D₂₁ and lower diodes D₁₂/D₂₂ and secondary side stacked capacitors that are unlabeled in FIG. 2 but can generally correspond to stacked capacitors C₁₁/C₁₂ and C₂₁/C₂₂. The outputs of the rectifiers of the respective converter module can be connected in parallel, i.e., with their high sides connected together and their low sides connected together, such that the output voltage Vout appears across the output of each converter module, i.e., across each rectifier.

The converter modules can be driven by phase-shifted PWM signals (described in greater detail below. In the illustrated case of two converter modules, the respective PWM signals can be phase shifted by 180 degrees. For three converter modules, the PWM signals can be phase shifted by 120 degrees; for four converter modules, the PWM signals can be phase shifted by 90 degrees. In other words, the phase shifts between the PWM signals for each converter module can be 360/n where n is the number of converter modules. This effectively multiplies the frequency of the input ripple current, which can reduce the size of the inductor L and other EMI filter components (not shown). The respective converter modules are “single stage” in that a rectified AC waveform connected to the input is converted directly to a DC output with only one switching stage (e.g., the input half bridge), as compared to multi-stage converters, as in FIG. 1 where the AC/DC conversion is separate from an isolated DC-DC conversions stage.

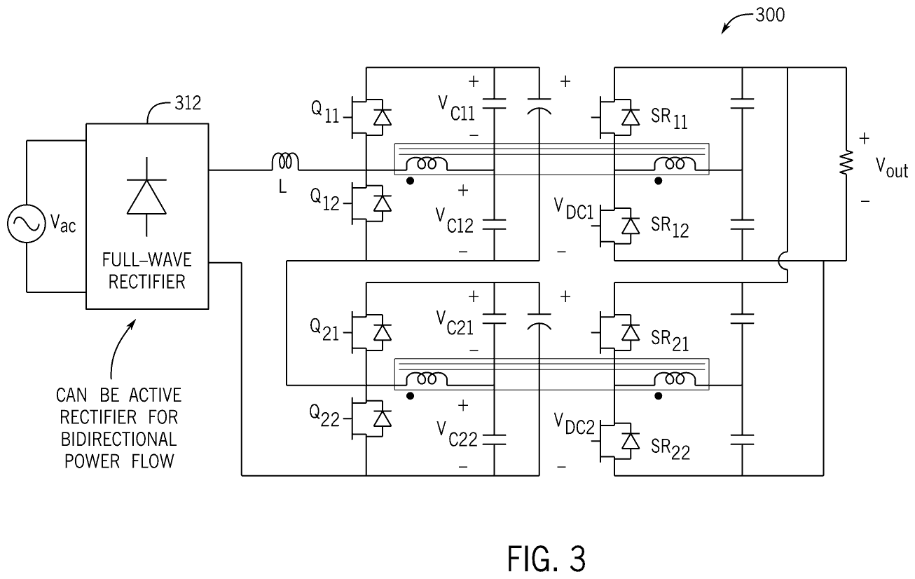

FIG. 3 illustrates an alternative embodiment of a proposed isolated power supply 300 that is a single-stage isolated AC-DC power supply with ISOP converter modules. Power supply 300 differs from power supply 200 in that the rectifier diodes D11, D12, D21, D22 have been replaced with synchronous rectifier switches SR11, SR12, SR21, SR22. Additionally, full wave rectifier 312 can be replaced with an active rectifier, which can allow for bidirectional power flow through the converter. Otherwise, the components, connection, and operation of the two power supplies 200, 300 are basically the same.

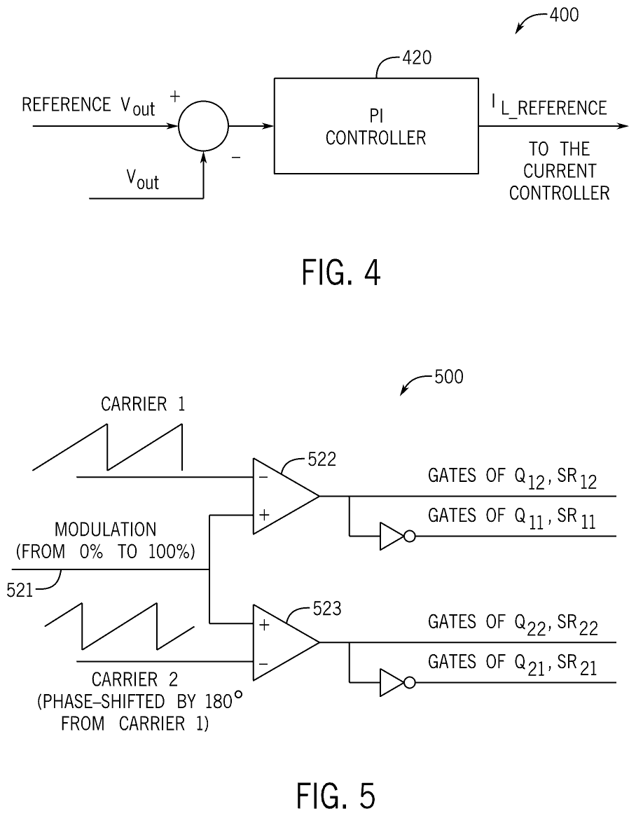

FIG. 4 illustrates a voltage control loop 400 of a single-stage isolated AC-DC power supply with ISOP converter modules. Voltage control loop 400 can be implemented as part of the control circuitry of the power supply, which can be implemented using any suitable combination of analog circuitry (sensors, amplifiers, etc.), digital circuitry (logic gates, flip flops, etc.), and/or programmable circuitry (microcontrollers, microprocessors, etc.). Such circuitry can be any combination of discrete components, integrated circuits, etc. The control circuitry can receive one or more sensed parameters from the power supply, such as input and output voltages, input and output currents, etc. The control circuitry can produce therefrom one or more control signals for operating the switching devices of the power supply, including the input half bridges of the respective modules, the synchronous rectifier switches of the respective modules, etc. The present disclosure illustrates simplified diagrams of only portions of the circuitry for brevity and clarity; however, the control circuitry can include additional components and functionality beyond that described herein, as desired for a given application.

Control loop 400 can monitor power supply output voltage Vout and compare it to a reference output voltage. The difference between these signals can be provided to a controller 420 that can generate a current reference signal for a current controller (not shown). Controller 420 can be a proportional-integral (“PI”) controller, or other controller, such as a proportional controller, proportional-integral-derivative (“PID”) controller, etc. The current controller (not shown) can generate the modulation signal 521 (FIG. 5) used to adjust the duty cycle of the PWM for the modules of the converter.

FIG. 5 illustrates pulse width modulation (PWM) control signal generation for a single-stage isolated AC-DC power supply with an ISOP converter. Modulation signal 521 can be compared with two triangle wave carrier signals (Carrier 1/Carrier 2) by comparators 522, 523, which can be phase-shifted by 180°. For a power supply with n converter modules, n comparators will be used, and the phase shift between the carrier signals is

$$\frac{360 °}{n} .$$

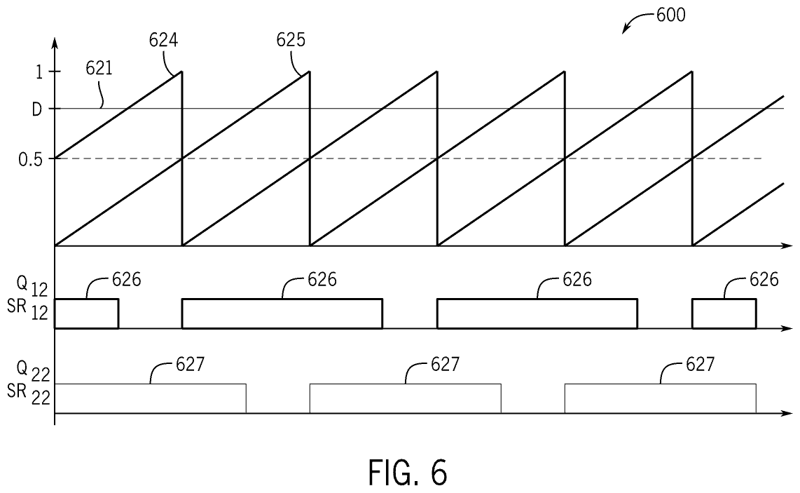

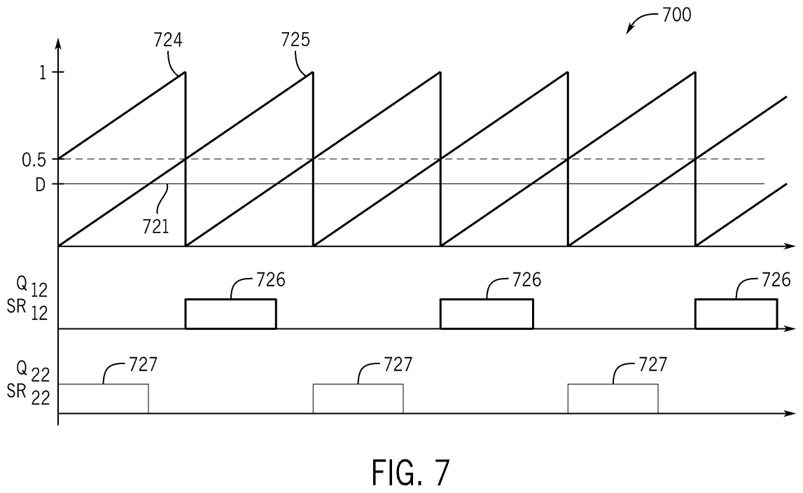

The output of comparator 522 (i.e., the result of the comparison of modulation signal 521 to Carrier 1 can produce an output that can be used to drive low side switch Q₁₂ of the first converter module, and also the low side synchronous rectifier switch SR₁₂ of the same module, if applicable. The complement of this signal can be used to drive high side switch Q₁₁ of the first converter module, and also the high side synchronous rectifier switch SR₁₁ of the same module, if applicable. Similarly, the output of comparator 523 (i.e., the result of the comparison of modulation signal 521 to Carrier 2 can produce an output that can be used to drive low side switch Q₂₂ of the second converter module, and also the low side synchronous rectifier switch SR₂₂ of the same module, if applicable. The complement of this signal can be used to drive high side switch Q₂₁ of the first converter module, and also the high side synchronous rectifier switch SR₂₁ of the same module, if applicable. This arrangement is further described with respect to FIGS. 6 and 7, below.

Modulation signal 521 (i.e., the duty cycle) determines not only the pulse width of individual switching pulses, but also the switching sequence of the converter. For example, a power supply with two converter modules can have two carrier signals that are phase-shifted from each other by 180°. If the duty cycle is greater than 50%, the switching sequence depicted in FIG. 6 will result, while if the duty cycle is less than 50%, the switching sequence shown in FIG. 7 will result. For a power supply with n modules, n carrier signals will be used with a phase-shift of

$$\frac{360 °}{n}$$

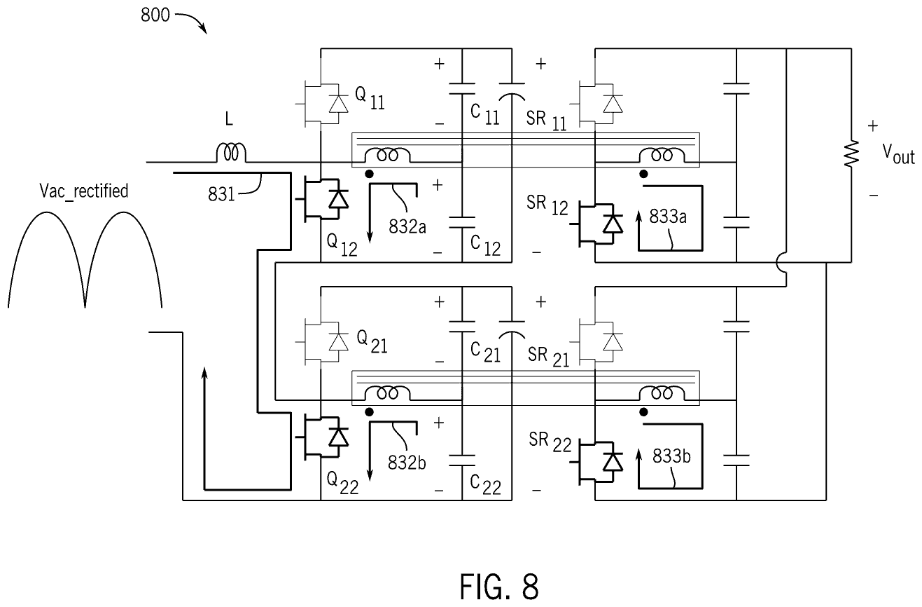

between each other. Each synchronous rectifier (if used) can be turned on/off with the same signals as the corresponding primary switches. When the proposed power supply includes two converter modules, it will have four switching states (determined by the states of low side switches Q₁₂ and Q₂₂). These four switching sequences are shown and described with reference to FIGS. 6 and 7, with corresponding power flow diagrams shown and described with reference to FIGS. 8-11.

FIG. 6 illustrates a switching sequence 600 of a single-stage isolated AC-DC power supply with an ISOP converter when a PWM duty cycle is >50%. Duty cycle signal 621 can be compared to respective triangle wave carrier signals 624/625. When the duty cycle signal is less than the corresponding carrier signal, the low side switches (Q₁₂/Q₂₂) of the respective converter modules can be turned on 626/627, and, conversely, the high side switches (Q₁₁/Q₁₂) can be turned off (not shown in FIG. 6). Likewise, during intervals when the low side switches (Q₁₂/Q₂₂) are turned off, the high side switches (Q₁₁/Q₁₂) can be turned on. As noted above, if synchronous rectification of the output is used, the same drive signals can be applied to the corresponding synchronous rectifier switches.

FIG. 7 illustrates a switching sequence of a single-stage isolated AC-DC power supply with an ISOP converter when a PWM duty cycle is <50%. Duty cycle signal 721 can be compared to respective triangle wave carrier signals 724/725. When the duty cycle signal is less than the corresponding carrier signal, the low side switches (Q₁₂/Q₂₂) of the respective converter modules can be turned on 726/727, and, conversely, the high side switches (Q₁₁/Q₁₂) can be turned off (not shown in FIG. 7). Likewise, during intervals when the low side switches (Q₁₂/Q₂₂) are turned off, the high side switches (Q₁₁/Q₁₂) can be turned on. As noted above, if synchronous rectification of the output is used, the same drive signals can be applied to the corresponding synchronous rectifier switches.

FIG. 8 illustrates power flow of a single-stage isolated AC-DC power supply 800 with ISOP converter modules when switches Q₁₂ and Q₂₂ are turned on. The rectified AC input voltage (Vac_rectified) can produce current 831 through low side switches Q₁₂/Q₂₂ of the converter modules. This results in corresponding low side primary current 832a/832b, which couples via the transformers of each converter module to induce low side secondary current 833a/833b on the secondary side of the respective converter modules. These low side secondary currents charge the corresponding output capacitors for ultimately delivering the output voltage to the load. As illustrated, synchronous rectifier switches SR₁₁/SR₁₂/SR₂₁/SR₂₂ are switched by control signals corresponding to the switching signals of the corresponding half bridge switching devices Q₁₁/Q₁₂/Q₂₁/Q₂₂, although if diodes were instead used for rectification on the secondary side, the described current flows and induced voltages would forward bias and reverse bias respective diodes to achieve a substantially similar result.

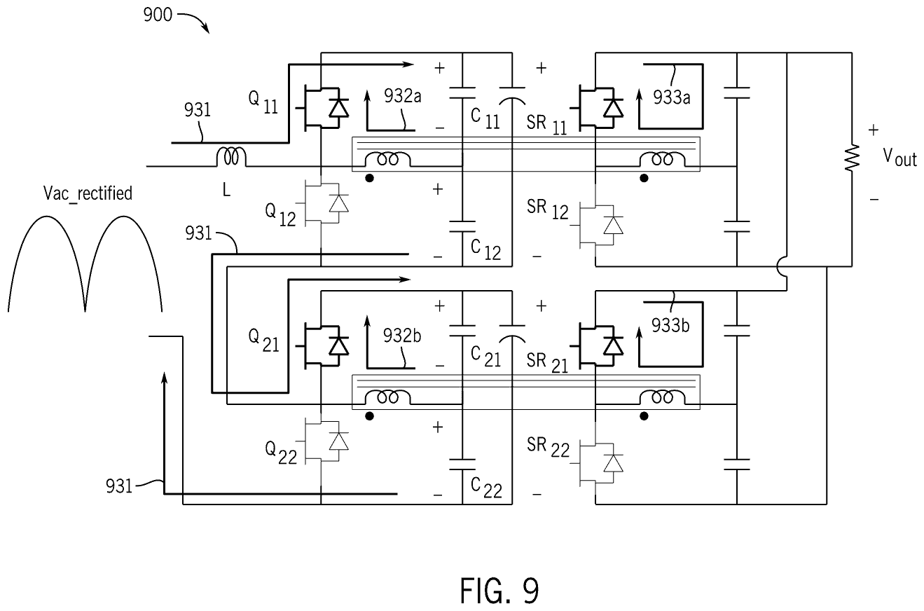

FIG. 9 illustrates power flow of a single-stage isolated AC-DC power supply with ISOP converter modules when switches Q₁₂ and Q₂₂ are turned off (and thus Q₁₁ and Q₂₁ are turned on). The rectified AC input voltage (Vac_rectified) can produce current 931 through high side switches Q₁₁/Q₂₁ of the converter modules. This results in corresponding high side primary currents 932a/932b, which couple via the transformers of each converter module to induce high side secondary currents 933a/933b on the secondary side of the respective converter modules. These high side secondary currents charge the corresponding output capacitors for ultimately delivering the output voltage to the load. As illustrated, synchronous rectifier switches SR₁₁/SR₁₂/SR₂₁/SR₂₂ are switched by control signals corresponding to the switching signals of the corresponding half bridge switching devices Q₁₁/Q₁₂/Q₂₁/Q₂₂, although if diodes were instead used for rectification on the secondary side, the described current flows and induced voltages would forward bias and reverse bias respective diodes to achieve a substantially similar result.

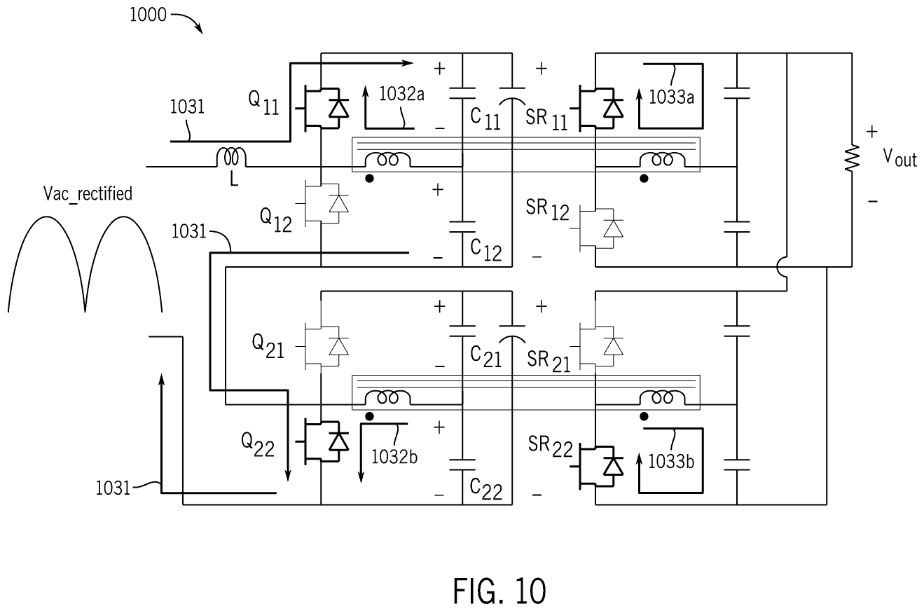

FIG. 10 illustrates power flow of a single-stage isolated AC-DC power supply with ISOP converter modules when switches Q₁₂ is turned off and Q₂₂ is turned on. The rectified AC input voltage (Vac_rectified) can produce current 1031 through high side switch Q₁₁ of the first converter module and low side switch Q₂₂ of the second converter module. This results in corresponding high side primary current 1032a in the first converter module and low side primary current 1032b in the second converter module. These primary currents couple via the transformers of each converter module to induce high side secondary current 1033a and low side secondary current 1033b on the secondary side of the respective converter modules. These secondary currents charge the corresponding output capacitors for ultimately delivering the output voltage to the load. As illustrated, synchronous rectifier switches SR₁₁/SR₁₂/SR₂₁/SR₂₂ are switched by control signals corresponding to the switching signals of the corresponding half bridge switching devices Q₁₁/Q₁₂/Q₂₁/Q₂₂, although if diodes were instead used for rectification on the secondary side, the described current flows and induced voltages would forward bias and reverse bias respective diodes to achieve a substantially similar result.

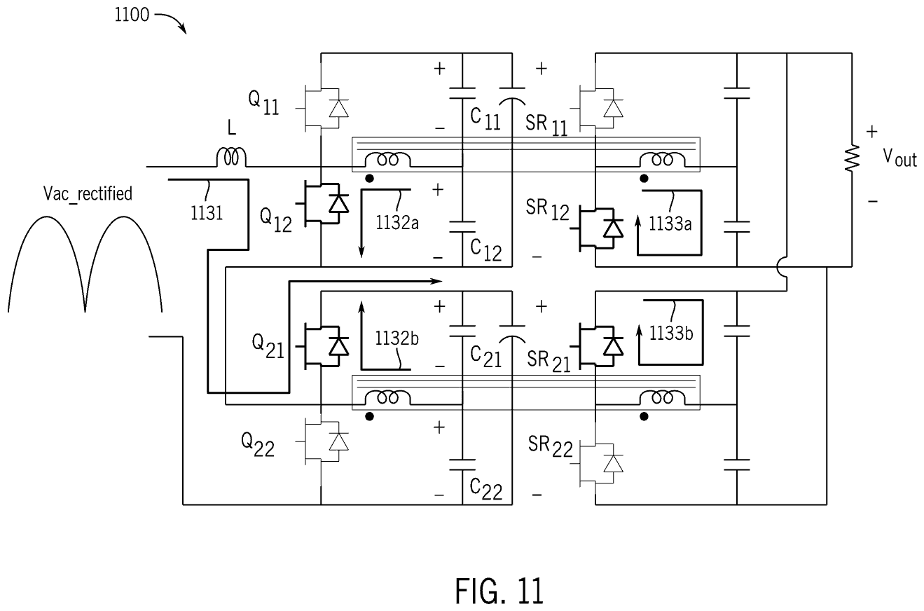

FIG. 11 illustrates power flow of a single-stage isolated AC-DC power supply with ISOP converter modules when switches Q₁₂ is turned on and Q₂₂ is turned off. The rectified AC input voltage (Vac_rectified) can produce current 1131 through low side switch Q₁₂ of the first converter module and high side switch Q₂₁ of the second converter module. This results in corresponding low side primary current 1132a in the first converter module and high side primary current 1132b in the second converter module. These primary currents couple via the transformers of each converter module to induce low side secondary current 1133a and high side secondary current 1133b on the secondary side of the respective converter modules. These secondary currents charge the corresponding output capacitors for ultimately delivering the output voltage to the load. As illustrated, synchronous rectifier switches SR₁₁/SR₁₂/SR₂₁/SR₂₂ are switched by control signals corresponding to the switching signals of the corresponding half bridge switching devices Q₁₁/Q₁₂/Q₂₁/Q₂₂, although if diodes were instead used for rectification on the secondary side, the described current flows and induced voltages would forward bias and reverse bias respective diodes to achieve a substantially similar result.

For a power supply with two converter modules, as illustrated in FIGS. 8-11, the voltages across respective capacitors are given by:

$${V}_{C 12} = {V}_{C 22} = \frac{{V}_{ac \_ rectified}}{2}$$

$${V}_{C 11} = {V}_{C 21} = \frac{D}{1 - D} ( \frac{{V}_{ac \_ rectified}}{2} )$$

$${V}_{DC 1} = {V}_{DC 2} = \frac{1}{1 - D} ( \frac{{V}_{ac \_ rectified}}{2} )$$

where V_{C12} is the voltage across capacitor C₁₂, V_{C22} is the voltage across capacitor C₂₂, V_{C11} is the voltage across capacitor C₁₁, V_{C21} is the voltage across capacitor C₂₁, V_{DC1} is the voltage across bulk capacitor C_{DC1}, V_{DC1} is the voltage across bulk capacitor C_{DC1}, and D is the duty cycle used for control of switching. Similarly, for a power supply with n converter modules, the corresponding voltages are given by:

$${V}_{C 12} = {V}_{C 22} = … = {V}_{Cn 2} = \frac{{V}_{ac \_ rectified}}{n}$$

$${V}_{C 12} = {V}_{C 22} = … = {V}_{Cn 2} = \frac{D}{1 - D} ( \frac{{V}_{ac \_ rectified}}{n} )$$

$${V}_{DC 1} = {V}_{DC 2} = … = {V}_{Dcn} = \frac{1}{1 - D} ( \frac{{V}_{ac \_ rectified}}{n} )$$

where the variables are as described above.

It will be further appreciated that the turns ratio of each module's transformer should take into account that the primary voltage is divided by n to produce the desired output voltage.

As described above, the control circuitry can provide other functionality beyond just generating the switching signals for the power supply and the respective converter modules. For example, overcurrent protection of the primary switches can be achieved via current sensors (such as current transformers, Hall effect sensors, current sense resistors, etc.) to sense the actual current flowing in the switches. The output of these current sensors can be connected to fast comparators (e.g., located inside a microcontroller) to quickly shut down the PWM signal when the current exceeds a threshold value and then wait for the next switching cycle. Also, such current sensors could be used to make sure that each converter module is sharing an equal amount of power, and any deviation can be corrected by increasing/decreasing the duty cycle of that converter module. Temperature sensors could also be provided to limit current flow or inhibit operation of the converter modules to prevent over temperature events. For a Low Cycle Drop Out (LCDO) event, when the AC grid is no longer detected, the control circuitry can cause the converter modules to (briefly) act as DC/DC converters, where the DC bulk capacitors act as DC sources.

The foregoing describes exemplary embodiments of single stage isolated AC/DC power supplies with input-series-output-parallel structures. Such configurations may be used in a variety of applications but may be particularly advantageous when used in conjunction with power supplies for computer processing systems and similar applications. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. An AC/DC power supply comprising:
a full wave rectifier that receives an AC input voltage and produces a rectified AC voltage;
a plurality of single stage AC/DC converter modules; and
an inductor that couples the rectified AC voltage to a first converter module of the plurality of single stage AC/DC converter modules;
wherein the plurality of single stage AC/DC converter modules have their inputs connected in series and their outputs connected in parallel.

2. The AC/DC power supply of claim 1 wherein the plurality of single stage AC/DC converter modules is two single stage AC/DC converter modules.

3. The AC/DC power supply of claim 2 wherein the two single stage AC/DC converter modules are driven 180 degrees out of phase with respect to each other.

4. The AC/DC power supply of claim 1 wherein the plurality of single stage AC/DC converter modules are driven 360/n degrees out of phase with respect to each other, where n is a number of single stage AC/DC converter modules in the plurality.

5. The AC/DC power supply of claim 1 wherein each of the plurality of single stage AC/DC converter modules comprises:
a switching half bridge including a high side switch and a low side switch, wherein a switch node of the switching half bridge is an input of the single stage AC/DC converter module;
a transformer having a primary winding with a first terminal connected to a switch node of the switching half bridge;
stacked switching capacitors respectively coupled between the switching half bridge and a second terminal of the primary winding of the transformer;
a rectifier half bridge coupled to a first terminal of a secondary winding of the transformer and an output of the single stage AC/DC converter module; and
stacked capacitors respectively coupled to the output of the single stage AC/DC converter module and between the rectifier half bridge and a second terminal of the secondary winding of the transformer.

6. The AC/DC power supply of claim 5 wherein the rectifier half bridge comprises synchronous rectifier switches.

7. The AC/DC power supply of claim 6 wherein respective high side and low side synchronous rectifier switches are driven by signals corresponding to corresponding high side and low side switches of the switching half bridge.

8. The AC/DC power supply of claim 1 further comprising control circuitry including:
a voltage controller that compares a difference between an output voltage of the power supply to a reference voltage to generate an error signal provided to a controller that generates a current command signal for a current controller; and
pulse width modulation circuitry that receives a modulation signal derived from the current command signal by the current controller and produces drive signals for switching devices of the plurality of single stage AC/DC converter modules by comparing the modulation signal to a plurality of phase shifted carriers, wherein the plurality of phase shifted carriers are shifted with respect to each other by 360/n degrees, where n is a number of single stage AC/DC converter modules in the plurality.

9. The AC/DC power supply of claim 8 wherein the pulse width modulation circuitry produces complementary drive signals for respective high side and low side switches of each single stage AC/DC converter module.

10. An AC/DC power supply comprising:
a full wave rectifier that receives an AC input voltage and produces a rectified AC voltage;
a plurality of single stage AC/DC converter modules; and
an inductor that couples the rectified AC voltage to a first converter module of the plurality of single stage AC/DC converter module;
wherein each of the plurality of single stage AC/DC converter modules comprises:
a switching half bridge including a high side switch and a low side switch, wherein a switch node of the switching half bridge is an input of the single stage AC/DC converter module;
a transformer having a primary winding with a first terminal connected to a switch node of the switching half bridge;
stacked switching capacitors respectively coupled between the switching half bridge and a second terminal of the primary winding of the transformer;
a rectifier half bridge coupled to a first terminal of a secondary winding of the transformer and an output of the single stage AC/DC converter module; and
stacked capacitors respectively coupled to the output of the single stage AC/DC converter module and between the rectifier half bridge and a second terminal of the secondary winding of the transformer; and
wherein the plurality of single stage AC/DC converter modules have their inputs connected in series and their outputs connected in parallel.

11. The AC/DC power supply of claim 10 wherein the rectifier half bridge comprises synchronous rectifier switches.

12. The AC/DC power supply of claim 11 wherein respective high side and low side synchronous rectifier switches are driven by signals corresponding to corresponding high side and low side switches of the switching half bridge.

13. The AC/DC power supply of claim 10 wherein the plurality of single stage AC/DC converter modules is two single stage AC/DC converter modules.

14. The AC/DC power supply of claim 13 wherein the two single stage AC/DC converter modules are driven 180 degrees out of phase with respect to each other.

15. The AC/DC power supply of claim 10 wherein the plurality of single stage AC/DC converter modules are driven 360/n degrees out of phase with respect to each other, where n is a number of single stage AC/DC converter modules in the plurality.

16. The AC/DC power supply of claim 10 further comprising control circuitry including:
a voltage controller that compares a difference between an output voltage of the power supply to a reference voltage to generate an error signal provided to a controller that generates a current command signal for a current controller; and
pulse width modulation circuitry that receives a modulation signal derived from the current command signal by the current controller and produces drive signals for switching devices of the plurality of single stage AC/DC converter modules by comparing the modulation signal to a plurality of phase shifted carriers, wherein the plurality of phase shifted carriers are shifted with respect to each other by 360/n degrees, where n is a number of single stage AC/DC converter modules in the plurality.

17. The AC/DC power supply of claim 16 wherein the pulse width modulation circuitry produces complementary drive signals for respective high side and low side switches of each single stage AC/DC converter module.

18. A single stage AC/DC converter module comprising:
a switching half bridge including a high side switch and a low side switch, wherein a switch node of the switching half bridge is an input of the single stage AC/DC converter module;
a transformer having a primary winding with a first terminal connected to a switch node of the switching half bridge;
stacked switching capacitors respectively coupled between the switching half bridge and a second terminal of the primary winding of the transformer;
a rectifier half bridge coupled to a first terminal of a secondary winding of the transformer and an output of the single stage AC/DC converter module; and
stacked capacitors respectively coupled to the output of the single stage AC/DC converter module and between the rectifier half bridge and a second terminal of the secondary winding of the transformer.

19. The single stage AC/DC converter module of claim 18 wherein the rectifier half bridge comprises synchronous rectifier switches.

20. The single stage AC/DC converter module of claim 19 wherein respective high side and low side synchronous rectifier switches are driven by signals corresponding to corresponding high side and low side switches of the switching half bridge.
